(19) United States
(12) Patent Application Publication
(10) Pub. No.: US 2023/0037309 A1
(43) Pub. Date: Feb. 9, 2023

(54) INFILL MATERIAL FOR ARTIFICIAL GRASS SURFACES, AN ARTIFICIAL GRASS SURFACE STRUCTURE AND A RECYCLING METHOD

(71) Applicant: POLYGREEN SRL, DENSENZANO DEL GARDA (IT)

(72) Inventors: Massimo BARALDI, Sirmione (IT); Roberto DIAN, Sirmione (IT); Riccardo MARITANO, Sirmione (IT)

(73) Assignee: POLYGREEN SRL, DENSENZANO DEL GARDA (IT)

(21) Appl. No.: 17/967,788

(22) Filed: Oct. 17, 2022

Related U.S. Application Data
(62) Division of application No. 16/098,063, filed on Oct. 31, 2018.

(30) Foreign Application Priority Data
May 5, 2016 (IT) 102016000046445

(51) Int. Cl. E01C 13/08; B29B 17/04

(52) U.S. Cl. CPC E01C 13/08; B29B 17/0412

(57) ABSTRACT

An artificial grass surface structure (1) for sports fields includes a mat (2) with filaments (4) which simulate a grass surface, and at least a filling layer (5) having a granular infill material (6) arranged between the filaments (4). The granular infill material for synthetic grass surfaces includes a plurality of granules (8) having a thermoplastic polymeric matrix and a load dispersed in the matrix. The load includes at least a cellulose-based vegetable component.

This application is a Divisional Application of U.S. application Ser. No. 16/098,063, filed 31 Oct. 2018 (the “371 Application”), which is a U.S. national stage application, under 35 USC 371, of PCT Application No. PCT/M2017/052531, filed 2 May 2017, which claims priority to and benefit of Italian Application No. 102016000046445, filed 5 May 2016 (the “Foreign Application”), each of which is incorporated by reference herein in its entirety. Pursuant to 37 CFR 1.55(h), the 371 Application is hereby identified as containing a certified copy of the Foreign Application.

### BACKGROUND OF THE INVENTION

The present invention relates to the sector of artificial grass surfaces, in particular for realizing sports fields. In particular, the present invention relates to an infill material to be used for filling artificial grass surfaces, and the relative artificial grass surface structure.

Artificial grass surfaces are generally constituted by a mat formed of filaments of polymeric material, which simulate a grassy lawn, and one or more filling materials, in granular, dispersed in the mat.

Filling materials, as is known, use silica sand or prevalently elastic materials, such as natural rubber, synthetic or vulcanized rubber, for example originating from recycling of tires, or materials of vegetable origin, such as tree fiber, coconut fiber, coco peat or cork, or materials having a thermoplastic origin, such as vinyl polymers, SBS, SEBS, polyurethane, polyethylene and the like. Filling or infill materials are typically subdivided into two categories:
stabilizing infill, commonly silica sands, which serve to give stability to the mat, ballasting the surface; these infills are commonly spread as a first filling layer.
performance infill, in general materials of polymeric or vegetable origin, which serve to give the mat excellent characteristics for sport, such as shock absorption, bounce, ball-rolling, comfort; these infills are commonly spread following the stabilizing infill, in one or more superposed layers.

The granules formed by materials of thermoplastic origin are generally constituted by a polymeric matrix with additives of mineral loads, such as calcium carbonate or talcum, for reducing the quantity of polymer (and therefore the price), as well as for giving some technical characteristics.

The granules are typically realized by extrusion and cutting; the cutting is done following the output in fluid form of the material through an die, a shape of which determines the dimension and form of the granule.

The granules are all of an identical size and notwithstanding the existence of granules of different shapes in the sector (egg-shaped, bean-shaped, cylinder-shaped, star-shaped, hollow tube-shaped, three-lobed, etc), all the shapes have been demonstrated to have a poor performance in terms of volume.

Further, the various forms of the granules have demonstrated respective drawbacks: for example, the egg and cylinder shapes showed poor stability inside the mat (with consequent translations and movement of the infill during rainfall); the tube shapes demonstrated poor resistance to treading with consequent crushing and a change of dimension.

Granules are also known which are formed by a polymeric matrix in which, instead of mineral loads, loads of vegetable origin, as illustrated, for example in document WO 2008/053389 or document WO 92/19669.

These granules too, however, have demonstrated some drawbacks, such as the poor availability of the raw material, or the difficulty of the production process, given the possibility of burning the vegetable component during the hot-extrusion.

There exists, therefore, a need for researching new granular infill materials, as the materials known today are not entirely satisfactory in terms of, for example, performance, volumetric performance, maintenance of moisture on the surface, costs, drainage capacity, degrading over time and environmental impact.

### SUMMARY OF THE INVENTION

The aim of the present invention is to provide a granular infill material for artificial grass surfaces which satisfies the needs of the sector and obviates the drawbacks that have been mentioned with reference to the prior art.

### BRIEF DESCRIPTION OF THE DRAWINGS

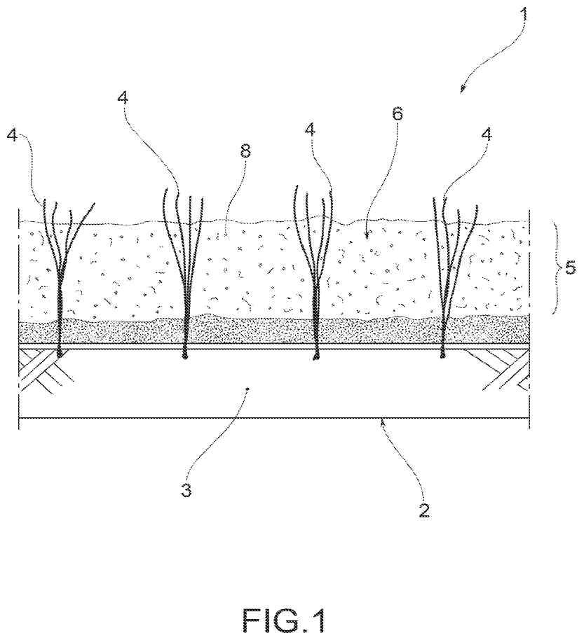

The characteristics and the advantages of the granular infill material according to present invention will emerge from the following description, given by way of non-limiting example, according to the appended table of drawings, in which FIG. 1 is a diagram of a grass surface with artificial grass containing a granular filling material according to the present invention.

### DETAIL DESCRIPTION OF THE PREFERRED EMBODIMENTS

With reference to FIG. 1, reference numeral 1 denotes in its entirety an artificial grass surface structure, in particular for sports fields.

The structure 1 comprises a mat 2 having a substrate 3 from which filaments 4 rise to simulate a grass surface.

The structure 1 further comprises a filling layer 5 formed by a granular infill material 6 arranged among the projecting filaments.

The granular material 6 is constituted by a mixture of granules 8, formed by a thermoplastic polymeric matrix and by a load dispersed in the matrix. The load includes at least a cellulose-based vegetable component. The vegetable load is preferably cellulose.

The cellulose is preferably present in a measure of between 20%-40% in weight, minimum and maximum included, preferably between 20%-30%, minimum and maximum included.

Said granules preferably originate from offcuts and waste of wallpaper or another cellulose-based material. Wallpaper is in fact constituted by a paper support on which a polymeric material is spread.

Further, the thermoplastic polymeric material of the matrix is preferably selected from among a group comprising vinyl resins, for example polyvinyl chloride (PVC), polyurethane, polyester, polypropylene.

The granular material according to the invention has an appreciable granular porosity; the porosity enables obtaining a water absorption that is particularly appreciated; the water absorption is preferably comprised between 10% and 60%, and is preferably 30%.

The water absorption is measured using a dedicated measuring method, which includes:
immersion in a water-filled container—of 1 kg of granular material (initially kept submerged, so that it is thoroughly soaked), for a predefined time, in general 10 minutes;
collecting the soaked granular material from the container, dripping the material on a perforated grid (typically with holes of 1 mm diameter), for a predefined time, generally up to the end of the dripping and for a minimum of 20 minutes;
weighing the soaked and dripped material;
calculating the water absorption in percentage form from the ratio with the dry weight of the granular material.

The granular material described in the foregoing can be obtained by a working process of the type described in Italian patent no. 10 2015 0000 2085 5, appropriately modified, the teachings of which are expressly incorporated herein.

In a preferred embodiment, the granular material and the artificial grass surface structure according to an embodiment of the present invention can be recycled.

The recycling method includes using, as performance infill, a granular material with a vegetable load based on cellulose, or cellulose, with added mineral loads and further vegetable components.

The method further includes a cutting step of the clump structure, ground and newly-re-forged, so as to newly obtain a material of an identical nature as that previously removed.

Said recycling method can be advantageously carried out in situ.

The granular material of the invention innovatively obviates the drawbacks of the prior art and meets the needs of the sector.

In fact, the granule of the invention generally has an irregular prismatic shape with a high apparent density, due to the vegetable component; this leads to excellent filling of the spaces, because of the shape of the granule, and a volumetric performance that is better than that of the traditional polymeric materials.

Further, the granule of the present invention has a high degree of porosity, able to retain rainwater, which cools the surface during dry days.

Further, the cost is advantageously very modest, as cellulose is abundant and easy to source, even where it does not originate from the recycling of wallpaper, but is added as a raw material to the polymeric material.

Further, and advantageously, by varying the quantity of cellulose present in the granule, it is possible to obtain infill material with various characteristics, for example more or less rigid, more or less hygroscopic or with a greater or lower apparent density.

Obviously, a technical expert in the sector, with the aim of satisfying contingent requirements, might make modifications to the granular material described in the foregoing, all of which fall within the scope of protection as defined in the claims that follow.

What is claimed is:

1. A process for producing an artificial grass surface structure for sports fields, the process comprising:
providing offcuts and waste of wallpaper, wherein the wallpaper comprises a paper support on which a polymeric material is spread;
obtaining granules from the offcuts and waste of wallpaper, wherein each of the granules comprises a thermoplastic polymeric matrix and a load dispersed in the matrix, the load being cellulose, and wherein the thermoplastic polymeric matrix originates from the polymeric material and the cellulose originates from the paper support;
providing a mat with filaments simulating a grass surface; and
providing a filling layer arranged between the filaments, wherein the filling layer includes a performance filling layer, comprising the granules, and a stabilizing filling layer below the performance filling layer.

2. The process according to claim 1, wherein the thermoplastic polymeric matrix comprises polyvinyl chloride.

3. The process according to claim 1, wherein the thermoplastic polymeric matrix comprises polyurethane.

4. The process according to claim 1, wherein each granule has a high degree of porosity with a water absorption of between 10% and 60%.

5. The process according to claim 1, further comprising incorporating a mineral load in the granules.

6. The process according to claim 1, wherein the cellulose is present in a measure of between 20%-40% by weight, minimum and maximum included.

7. The process according to claim 6, wherein the cellulose is present in a measure of between 20%-30% by weight, minimum and maximum included.

8. The process according to claim 1, wherein the granules have an irregular and prismatic shape.
